(19) United States
(12) Patent Application Publication
(10) Pub. No.: US 2025/0372361 A1
(43) Pub. Date: Dec. 4, 2025

(54) Varying Turbo Pump Speed to Optimize Pressure Levels within a Mass Spectrometer

(71) Applicant: Thermo Finnigan LLC, San Jose, CA (US)

(72) Inventors: Graeme C. McAlister, San Jose, CA (US); Christopher Mullen, Menlo Park, CA (US)

(21) Appl. No.: 18/680,984

(22) Filed: May 31, 2024

(51) Int. Cl. H01J 49/24; H01J 49/00

(52) U.S. Cl. CPC H01J 49/24; H01J 49/0027

(57) ABSTRACT

A pump management system may determine an operating mode for a mass spectrometer; set, based on the operating mode, a pump speed of a turbo pump used to create one or more vacuum stages for the mass spectrometer; and cause the turbo pump to operate at the pump speed while the mass spectrometer operates in accordance with the operating mode. Additionally or alternatively, the pump management system may monitor, using one or more instruments external to the turbo pump, a condition associated with the mass spectrometer while the mass spectrometer operates in accordance with the operating mode; determine, based on the monitoring, that the condition changes by more than a threshold value; and adjust, based on the condition changing by more than the threshold value and while the mass spectrometer is in operation, the pump speed.

### BACKGROUND INFORMATION

A turbo pump is commonly used to create and maintain one or more vacuum stages for a mass spectrometer. For example, a turbo pump may operate to remove gas molecules from a region of the mass spectrometer, thereby decreasing pressure within the region to extremely low levels required for accurate mass analysis by the mass spectrometer.

The pressure level requirements for a particular region of a mass spectrometer may vary depending on a number of different factors. For example, mass spectrometers are tasked with analyzing a wide range of molecules—from extremely small molecules to massive protein complexes. Different molecules typically require different pressure levels to effectively be analyzed by a mass spectrometer. For example, relatively larger ions may require relatively higher pressure levels to effectively cool the ions before they are transmitted. However, these relatively higher pressure levels may be problematic for smaller molecules and peptide ions, as higher pressure levels may cause long ion flight times that slow down spectral acquisition rates and degrade ion detector performance. As such, some mass spectrometry systems may include dedicated hardware, such as pressure sensors and gas regulators, that facilitate manual adjustment of pressure levels within a vacuum chamber (e.g., by increasing or decreasing the flow of nitrogen into the vacuum chamber). Unfortunately, these components may increase the complexity and cost of mass spectrometry systems and can disadvantageously require placement of system optics in confined spaces that are easy to pressurize.

Another approach to account for the different pressure requirements is to set the pressure within a region of the mass spectrometer to always be at a relatively low level. This may disadvantageously create unnecessarily high temperature levels and/or other suboptimal conditions within the mass spectrometer, which may in turn require extended periods of downtime for the mass spectrometer cool down.

### SUMMARY

The following description presents a simplified summary of one or more aspects of the systems and methods described herein. This summary is not an extensive overview of all contemplated aspects and is intended to neither identify key or critical elements of all aspects nor delineate the scope of any or all aspects. Its sole purpose is to present one or more aspects of the systems and methods described herein as a prelude to the detailed description that is presented below.

In some illustrative embodiments, a method comprises determining, by a pump management system, an operating mode for a mass spectrometer; setting, by the pump management system based on the operating mode, a pump speed of a turbo pump used to create one or more vacuum stages for the mass spectrometer; and causing, by the pump management system, the turbo pump to operate at the pump speed while the mass spectrometer operates in accordance with the operating mode.

In some illustrative embodiments, a method comprises monitoring, by a pump management system using one or more instruments external to a turbo pump used to create one or more vacuum stages for a mass spectrometer, a condition associated with the mass spectrometer while the mass spectrometer is in operation; determining, by the pump management system based on the monitoring, that the condition changes by more than a threshold value; and adjusting, by the pump management system based on the condition changing by more than the threshold value and while the mass spectrometer is in operation, a pump speed of the turbo pump.

In some illustrative embodiments, a system comprises a mass spectrometer configured to analyze molecules of a sample; a computing device communicatively coupled with the mass spectrometer and configured to perform a process comprising: determining an operating mode for the mass spectrometer; setting, based on the operating mode, a pump speed of a turbo pump used to create one or more vacuum stages for the mass spectrometer; and causing the turbo pump to operate at the pump speed while the mass spectrometer operates in accordance with the operating mode.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 shows an illustrative configuration in which a pump management system is communicatively coupled with a mass spectrometer.

FIG. 2 shows illustrative components of a pump management system.

FIG. 3 shows an illustrative implementation of the configuration shown in FIG. 1.

FIG. 4 shows an illustrative method for managing a turbo pump for a mass spectrometer.

FIG. 5 shows an illustrative method for managing a turbo pump for a mass spectrometer.

FIGS. 6A and 6B show an illustrative configuration for managing a turbo pump for a mass spectrometer.

FIG. 7 shows an illustrative computing device that may be specifically configured to perform one or more of the operations, methods, and processes described herein.

### DETAILED DESCRIPTION

Systems and methods for optimizing pressure levels within a mass spectrometer are described herein. For example, as described herein, a turbo pump having a variable pump speed may be used to create one or more vacuum stages within a mass spectrometer. A pump management system may control the pump speed of the turbo pump to set the pressure within the one or more vacuum stages to a level that is optimized or otherwise acceptable for a particular operating mode of the mass spectrometer and/or a particular condition associated with the mass spectrometer.

For example, the pump management system may determine an operating mode for a mass spectrometer (e.g., prior to the mass spectrometer beginning to operate in accordance with the operating mode), set, based on the operating mode, a pump speed of the turbo pump, and cause the turbo pump to operate at the pump speed while the mass spectrometer operates in accordance with the operating mode. Additionally or alternatively, the pump management system may monitor, using one or more instruments external to the turbo pump, a condition (e.g., temperature, pressure, etc.) associated with the mass spectrometer while the mass spectrometer is in operation, determine, based on the monitoring, that the condition changes by more than a threshold value, and adjust, based on the condition changing by more than the threshold value and while the mass spectrometer is in operation, the pump speed.

As used herein, a “vacuum stage” created and maintained by a turbo pump may refer to any pressurized space or region within, surrounding, or otherwise affecting one or more components of a mass spectrometer. For example, a vacuum stage may refer to any space or region within a mass spectrometer within which the pressure is sufficiently lower than atmospheric pressure (e.g., less than 1×10−3 mbar). Creating a vacuum stage using a turbo pump may include the turbo pump performing any suitable process to create and/or maintain a desired pressure level within the space or region of the vacuum stage. For example, to create a vacuum stage, the turbo pump may operate to remove gas molecules from a region (e.g., a chamber or other enclosed area) of a mass spectrometer. This may be done in various ways as described herein.

As used herein, a “pump speed” of a turbo pump refers to any setting of the turbo pump that determines a rate at which the turbo pump creates a vacuum stage (e.g., by removing gas molecules from a chamber). For example, the pump speed may be a setting (e.g., measured in rotations per minute) that specifies a frequency at which one or more fan blades rotate within the turbo pump to create a vacuum stage.

As described herein, the pump speed of a turbo pump associated with a mass spectrometer may be variable and controllable. By controlling the pump speed of a turbo pump associated with a mass spectrometer, the systems and methods described herein may optimize one or more pressure levels within a mass spectrometer based on the mass spectrometer's operating mode and/or any other conditions or factors associated with the mass spectrometer. This may obviate the need for other types of dedicated hardware (e.g., pressure sensors and gas regulators) to control pressure levels, maximize mass spectrometer flexibility when heating and cooling components in the mass spectrometer, and/or provide other benefits as described herein.

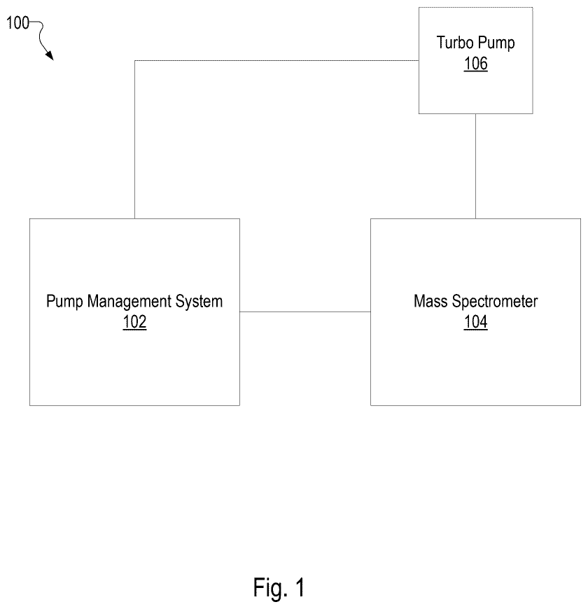

FIG. 1 shows an illustrative configuration 100 in which a pump management system 102 is communicatively coupled with a mass spectrometer 104 and a turbo pump 106. Mass spectrometer 104 may be implemented by any suitable type of mass spectrometer, such as a quadrupole mass spectrometer, an ion trap mass spectrometer, a time-of-flight mass spectrometer, and/or a magnetic sector mass spectrometer. Mass spectrometer 104 may include any number of additional or alternative components (e.g., one or more mass analyzers) as may serve a particular implementation. An illustrative implementation of mass spectrometer 104 may include an Orbitrap™ Tribrid™ mass spectrometer manufactured and sold by Thermo Fisher Scientific, Inc., Waltham, MA.

Turbo pump 106 may be configured to create one or more vacuum stages for mass spectrometer 104. Turbo pump 106 may be implemented by any suitable type of pump, such as a turbomolecular pump, an ion pump, a rotary vane pump, a diffusion pump, and/or a cryogenic pumps. In some implementations, turbo pump 106 may include one or more rotor blades configured to rotate at a definable frequency to move gas molecules out of a region of mass spectrometer 104 and thereby create a vacuum within the region.

In some embodiments, turbo pump 106 may be a multi-stage pump configured to create multiple vacuum stages. The vacuum stages may be created within any suitable combination of components of mass spectrometer 104, such as ion sources, mass analyzers, mass filters, collision cells, and/or detectors.

Pump management system 102 may be configured to perform various operations for managing turbo pump 106. For example, pump management system 102 may be configured to set various parameters for controlling the operation of turbo pump 106, such as a pump speed (also referred to herein as a “turbo pump speed”) associated with turbo pump 106, a backing pressure associated with turbo pump 106, a cooling method (e.g., air cooling, water cooling, etc.) associated with turbo pump 106, and/or a monitoring frequency associated with turbo pump 106. As described herein, pump management system 102 may be configured to set a pump speed of turbo pump 106 based on an operating mode for mass spectrometer 104 and/or one or more conditions associated with mass spectrometer 104.

Pump management system 102 may be implemented by any combination of one or more computing devices. For example, pump management system 102 may be implemented by a controller included in or otherwise associated with mass spectrometer 104, one or more computing devices configured to be communicatively coupled with mass spectrometer 104 and/or turbo pump 106, and/or any other local and/or remote computing device as may serve a particular implementation.

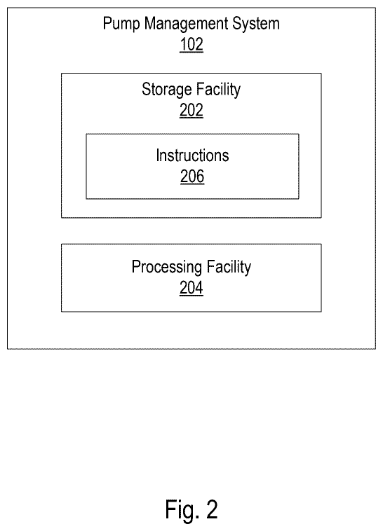

FIG. 2 shows illustrative components of pump management system 102. For example, pump management system 102 may include, without limitation, a storage facility 202 and a processing facility 204 selectively and communicatively coupled to one another. Facilities 202 and 204 may each include or be implemented by hardware and/or software components (e.g., processors, memories, communication interfaces, instructions stored in memory for execution by the processors, etc.). In some examples, facilities 202 and 204 may be distributed between multiple devices and/or multiple locations as may serve a particular implementation. For example, facilities 202 may be distributed between one or more local compute resources and one or more remote compute resources communicatively coupled to the local compute resources by way of a network.

Storage facility 202 may be implemented by any suitable non-transitory computer-readable medium and/or non-transitory processor-readable medium, such as any combination of non-volatile storage media and/or volatile storage media. In some examples, storage facility 202 may maintain (e.g., store) executable data used by processing facility 204 to perform any of the operations described herein. For example, storage facility 202 may store instructions 206 that may be executed by processing facility 204 to perform any of the operations described herein. Instructions 206 may be implemented by any suitable application, software, code, and/or other executable data instance. Storage facility 202 may also maintain any data acquired, received, generated, managed, used, and/or transmitted by processing facility 204.

Processing facility 204 may be configured to perform (e.g., execute instructions 206 stored in storage facility 202 to perform) various processing operations described herein. It will be recognized that the operations and examples described herein are merely illustrative of the many different types of operations that may be performed by processing facility 204. In the description herein, any references to operations performed by pump management system 102 may be understood to be performed by processing facility 204 of pump management system 102. Furthermore, in the description herein, any operations performed by pump management system 102 may include pump management system 102 directing and/or instructing another computing system, device, or apparatus to perform the operations.

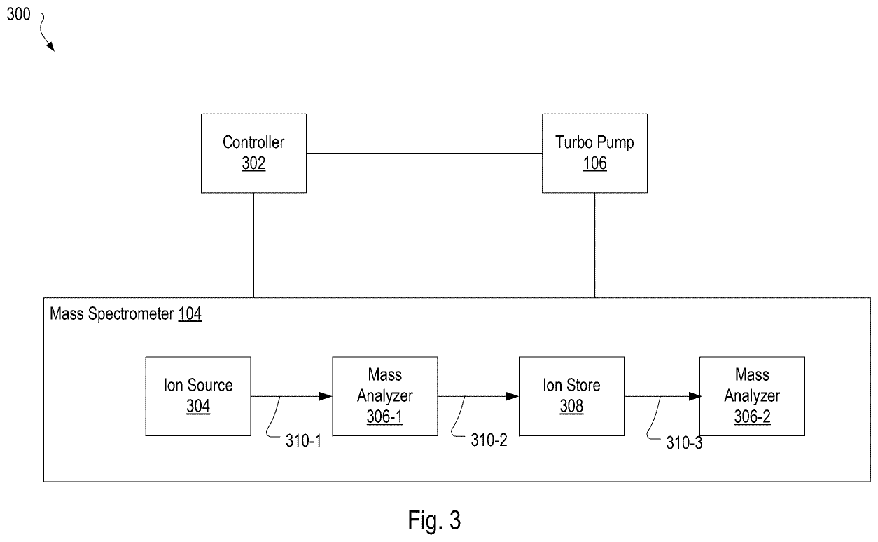

FIG. 3 shows an illustrative implementation 300 of configuration 100. implementation 300. As shown, implementation 300 may include mass spectrometer 104, turbo pump 106, and a controller 302. Implementation 300 may further include any additional or alternative components not shown as may suit a particular implementation (e.g., ion optics, lenses, filters, ion storage devices, ion mobility analyzers, collision cells, ion flux monitors, etc.).

Mass spectrometer 104 may include any number of components for performing operations related to mass spectrometry. As shown, mass spectrometer 104 may include an ion source 304, one or more mass analyzers 306 (e.g., mass analyzers 306-1 and 306-2), and an ion store 308.

Ion source 304 may be configured to produce ions from a sample and deliver the ions in an ion stream 310-1 to mass analyzer 306-1. The sample may be produced in any suitable manner, such as by using a liquid chromatography procedure. Ion source 304 may use any suitable ionization technique, including without limitation electron ionization, chemical ionization, matrix assisted laser desorption/ionization, electrospray ionization, atmospheric pressure chemical ionization, atmospheric pressure photoionization, inductively coupled plasma, and the like. Ion source 304 may include various components for producing ions from a sample and delivering the ions to mass analyzer 306-1.

Mass analyzers 306 may be implemented by any suitable mass analyzer, such as a linear multipole mass analyzer (e.g., a quadrupole mass analyzer), an Orbitrap™ mass analyzer, an ion trap mass analyzer, and/or a time-of-flight mass analyzer. Mass analyzer 306-1 may filter ion stream 310-1 to selectively transmit ions within a selected m/z range in an ion stream 310-2 to ion store 308. While implementation 300 is shown to include mass analyzer 306-1, alternative implementations may omit mass analyzer 306-1 and only include mass analyzer 306-2. In these alternative implementations, ion stream 310-1 may be provided directly to ion store 308 from ion source 304.

Ion store 308 may be implemented by a device configured to accumulate, over an accumulation time, ions included in ion stream 310-2. As used herein, “accumulation time” refers to the duration of time during which ions produced by ion source 304 accumulate in ion store 308 prior to being released and transferred to mass analyzer 306-2. Accumulation time may also be known as ion injection time or ion fill time. In some examples, ion store 308 may be an ion storage device configured to buffer down-stream processes, such as mass analysis, thereby increasing acquisition speed and instrument sensitivity. In some examples, ion store 308 may be a beam-type device or a trapping device, such as a multipole ion guide (e.g., a quadrupole ion guide, a hexapole ion guide, an octupole ion guide, etc.), a linear quadrupole ion trap, a three-dimensional quadrupole ion trap, a cylindrical ion trap, a toroidal ion trap, an orbital electrostatic trap, a Kingdon trap, and the like. In some examples, ion store 308 may take the form of a curved trap (also known as a C-trap) of the type used with orbital electrostatic trap mass spectrometers. In some examples, ion store 308 may be omitted from implementation 300. In these examples, mass analyzer 306-2 (and/or another component of mass spectrometer 104) may function as an ion store (e.g., for additional mass analyzers of mass spectrometer 104).

In some examples, ion store 308 may be a collision cell positioned upstream from mass analyzer 306-2. As used herein, a “collision cell” may refer to any device arranged to produce product ions via controlled dissociation processes or ion-ion reaction processes and is not limited to devices employed for collisionally-activated dissociation. For example, a collision cell may be configured to fragment the ions using collision induced dissociation (CID), electron transfer dissociation (ETD), electron capture dissociation (ECD), photo-induced dissociation (PID), surface induced dissociation (SID), and the like.

The accumulation of ions in ion store 308 may be regulated by automatic gain control and/or any other technique to achieve a target population of ions in ion store 308 and, hence, a target signal density. The accumulation of ions may be regulated in any suitable way. In some examples, the accumulation of ions in ion store 308 is regulated by a gate apparatus (not shown) that either transmits or blocks ion stream 310-2. The gate may be opened for a given amount of time to meter the appropriate number of ions, after which the gate is closed. The accumulated ions may then be transferred in ion stream 310-3 from ion store 308 to mass analyzer 306-2. A gate apparatus may also be used to regulate transmission of ion stream 310-2. It will be recognized that other techniques for the regulation of ion accumulation may be used.

Mass analyzer 306-2 may be configured to perform mass analysis on ion populations (e.g., during a tandem mass spectrometry process). As shown, mass analyzer 306-2 may analyze ions received from ion stream 310-3 (e.g., ions that have fragmented within ion store 308). In some examples, mass analyzer 306-2 may include an ion detector configured to detect ions at each of a variety of different m/z and responsively generate an electrical signal representative of ion intensity. The electrical signal may be transmitted to controller 302 for processing, such as to construct a mass spectrum of the detected ions. For example, mass analyzer 306-2 may generate and/or provide data that can be used by controller 302 to construct a mass spectrum.

As used herein, “mass spectrum” or “spectrum” refers to a plot of intensity of ions as a function of m/z of the ions. As used herein, “intensity” or “signal intensity” refers to the response of an ion detector included within one or more of mass analyzers 306 and may represent absolute abundance, relative abundance, ion count, intensity, relative intensity, ion current, or any other suitable measure of ion detection.

Controller 302 may implement some or all of the functionality performed by pump management system 102. For example, controller 302 may be configured to control operation of various hardware components included in turbo pump 106, ion source 304, mass analyzers 306, and/or ion store 308. To illustrate, controller 302 may be configured to set a pump speed of turbo pump 106, control an accumulation time of ion store 308, control an oscillatory voltage power supply and/or a DC power supply to supply an RF voltage and/or a DC voltage to mass analyzers 306, adjust values of the RF voltage and DC voltage to select an effective m/z (including a mass tolerance window) for analysis, and/or adjust the sensitivity of ion detection performed by mass analyzers 306 (e.g., by adjusting detector gain).

Controller 302 may also include and/or provide a user interface configured to enable interaction between a user and controller 302. For example, a user may interact with the user interface to select a desired operating mode for mass spectrometer 104 via the user interface. The user may interact with controller 302 via the user interface by tactile, visual, auditory, and/or other sensory type communication. For example, the user interface may include a display device (e.g., liquid crystal display (LCD) display screen, a touch screen, etc.) for displaying information (e.g., mass spectra, notifications, etc.) to the user. The user interface may also include an input device (e.g., a keyboard, a mouse, a touchscreen device, etc.) that allows the user to provide input to controller 302. In other examples, the display device and/or input device may be separate from, but communicatively coupled to, controller 302. For instance, the display device and the input device may be included in a computer (e.g., a desktop computer, a laptop computer, a mobile device, etc.) communicatively connected to controller 302 by way of a wired connection (e.g., by one or more cables) and/or a wireless connection (e.g., Wi-Fi, Bluetooth, near-field communication, etc.).

Controller 302 may include any suitable hardware (e.g., a processor, circuitry, etc.) and/or software as may serve a particular implementation. In some examples, controller 302 may be implemented by a computing device communicatively coupled to mass spectrometer 104 and/or turbo pump 106 by way of a wired connection (e.g., a cable) and/or a network (e.g., a local area network, a wireless network (e.g., Wi-Fi), a wide area network, the Internet, a cellular data network, etc.). In some embodiments, controller 302 may be a component of mass spectrometer 104.

The methods, systems, and apparatuses described herein may operate as part of or in conjunction with implementation 300 described herein and/or with any other suitable mass spectrometer or mass spectrometry system, including a combined separation-mass spectrometry system such as a liquid chromatography-mass spectrometry system (LC-MS), a high-performance liquid chromatography-mass spectrometry (HPLC-MS) system, a gas chromatography-mass spectrometry (GC-MS) system, a capillary electrophoresis-mass spectrometry (CE-MS) system, or an ion mobility system (IM-MS). The methods, systems, and apparatuses described herein may also operate in conjunction with a continuous flow sample source, such as in flow-injection mass spectrometry (FI-MS) in which analytes are injected into a solvent without separation in a column and enter the mass spectrometer.

Turbo pump 106 may create one or more vacuum stages within any number of the aforementioned components of mass spectrometer 104. In some embodiments, each vacuum stage may correspond to a unique component of mass spectrometer 104. For example, a first vacuum stage may correspond to ion source 304 and a second vacuum stage may correspond to mass analyzer 306-1.

While implementation 300 is illustrated as including a single turbo pump 106, it is to be appreciated that implementation 300 may include any number of turbo pumps for creating the vacuum stages. For example, a first turbo pump may create a vacuum stage corresponding to a first component of mass spectrometer 104, and a second turbo pump may create a second vacuum stage corresponding to a second component of mass spectrometer 104. In some examples, controller 302 may manage multiple turbo pumps for creating multiple vacuum stages. Controller 302 may selectively adjust any combination of the turbo pumps based on a condition associated with mass spectrometer 104. For example, pump management system 102 may maintain the pump speed of one or more turbo pumps of the multiple turbo pumps while adjusting the pump speed of one or more other turbo pumps of the multiple turbo pumps. In some embodiments, the one or more turbo pumps may be associated with one or more earlier stages for the mass spectrometer than the one or more other turbo pumps. For example, the one or more turbo pumps may be associated with mass analyzer 306-1 while the particular turbo pump is associated with mass analyzer 306-2.

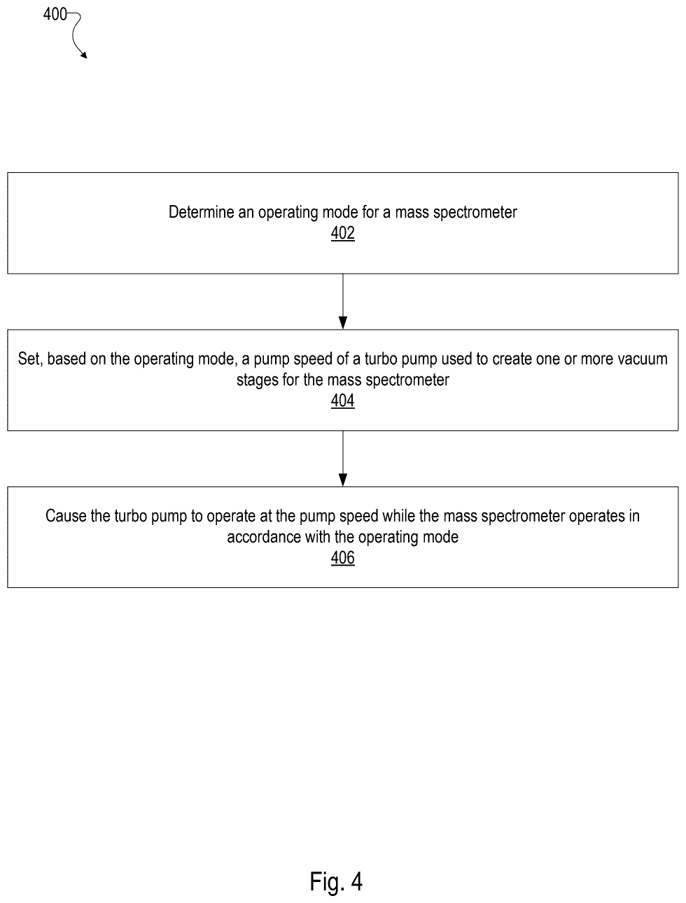

FIG. 4 shows an illustrative method 400 for managing a turbo pump used to create and maintain one or more vacuum stages for a mass spectrometer. While FIG. 4 shows illustrative operations according to one embodiment, other embodiments may omit, add to, reorder, and/or modify any of the operations shown in FIG. 4. One or more of the operations shown in FIG. 4 may be performed by pump management system 102, one or more components included therein, and/or any implementation thereof.

At operation 402, pump management system 102 may determine an operating mode for a mass spectrometer (e.g., mass spectrometer 104). The operating mode may specify one or more operating parameters of the mass spectrometer that define how mass spectrometer performs a particular analysis during operation and/or any other manner in which the mass spectrometer is to operate. For example, the one or more operating parameters may specify a data acquisition rate associated with the mass spectrometer, a calibration frequency associated with the mass spectrometer, a gas flow rate associated with the mass spectrometer, a fragmentation voltage associated with the mass spectrometer, a resolution setting associated with the mass spectrometer, and/or any other characteristic associated with the mass spectrometer.

Pump management system 102 may determine an operating mode for a mass spectrometer in any suitable manner. For example, pump management system 102 may obtain (e.g., receive, detect, or otherwise access) input data and determine the operating mode based on the input data. The input data may be provided by a user (e.g., a user interacting with a user interface associated with the mass spectrometer), one or more components within the mass spectrometer, and/or one or more instruments (e.g., gauges, sensors, etc.) configured to monitor one or more conditions associated with the mass spectrometer. For example, the input data may include data representative of a predefined operating mode for the mass spectrometer and/or one or more characteristics associated with the mass spectrometer (e.g., a data acquisition rate associated with the mass spectrometer, a calibration frequency associated with the mass spectrometer, a gas flow rate associated with the mass spectrometer, a fragmentation voltage associated with the mass spectrometer, a resolution setting associated with the mass spectrometer, etc.).

As mentioned, the input data used to determine an operating mode for a mass spectrometer may include user input data. For example, the user input data may be representative of a selection by the user of a particular operating mode for the mass spectrometer. To illustrate, a user may interact with a user interface to select a particular operating mode for the mass spectrometer from a list of predefined operating modes presented within the user interface. The user interface may be provided by an application executed by a computing device configured to control the mass spectrometer. The computing device may cause the mass spectrometer to operate in accordance with the selected operating mode.

Any number of operating modes may be included in the list of predefined operating modes from which a user may select. For example, the predefined operating modes may include different operating modes associated with different molecule sizes or types of samples to be analyzed by the mass spectrometer, one or more operating modes associated with a bakeout process that may be performed for one or more components of the mass spectrometer, one or more operating modes associated with different types of mass spectrometry processes that may be performed by the mass spectrometer, etc. Each of these operating modes may require or may otherwise be optimized by different pressure levels within one or more vacuum stages created by a turbo pump associated with the mass spectrometer. Examples of this are described herein.

In some embodiments, the user input data used to determine an operating mode for a mass spectrometer may be representative of a selection or setting by a user of one or more parameters that define how the mass spectrometer is to operate. For example, a user may select a particular data acquisition rate for the mass spectrometer. Pump management system 102 may accordingly determine the operating mode based on the selected data acquisition rate.

In some embodiments, the operating mode may be determined by pump management system 102 based on a determination that the mass spectrometer will operate to perform a specific type of mass spectrometry process. For example, pump management system 102 may determine that the mass spectrometer will operate to perform a collision-based mass spectrometry process (e.g., a collision-induced dissociation process that induces fragmentation of selected ions in the gas phase). This particular process may require or otherwise be optimized by a relatively high pressure level within one or more vacuum stages created by a turbo pump associated with the mass spectrometer.

In some embodiments, pump management system 102 may determine the operating mode for the mass spectrometer by identifying a characteristic of a sample to be analyzed by the mass spectrometer. The characteristic of the sample may include any suitable characteristic of the sample, such as a molecule size of the sample (e.g., a relatively large molecule size, a relatively small molecule size, etc.), a physical state of the sample, a solubility level of the sample, a composition class of the sample, a coloring of the sample, a hardness level of the sample, and/or a stability level of the sample. For example, the operating mode may be determined based determining that the sample belongs to a particular composition class, such as an oligonucleotide, a macromolecule, a polymer, an inorganic compound, and/or an environmental compound.

In some embodiments, pump management system 102 may determine the operating mode for the mass spectrometer by determining that the mass spectrometer will operate to perform a bakeout process for one or more components of the mass spectrometer. The bakeout process may involve heating one or more components of the mass spectrometer to an extremely high temperature to remove contaminants, such as water vapor, residual gases, and/or hydrocarbons. Pump management system 102 may determine that the mass spectrometer will operate to perform the bakeout process by determining that one or more heaters associated with the mass spectrometer will be enabled and/or in any other suitable manner.

Pump management system 102 may determine the operating mode for the mass spectrometer at any suitable time. For example, the operating mode may be determined prior to the mass spectrometer operating in accordance with the operating mode (e.g., prior to the mass spectrometer being used to analyze a sample). In some examples, the operating mode may be determined during a temporary shutdown period of the mass spectrometer after the mass spectrometer begins operating and/or in real-time while the mass spectrometer is analyzing a sample.

At operation 404, pump management system 102 may set, based on the operating mode, a pump speed of a turbo pump (e.g., turbo pump 106) used to create one or more vacuum stages for the mass spectrometer. As described above, the pump speed may refer to any setting of the turbo pump that determines a rate at which the turbo pump creates one or more vacuum stages. For example, the pump speed may be a setting (e.g., measured in rotations per minute) that specifies a frequency at which one or more fan blades rotate within the turbo pump to create a vacuum stage.

At operation 406, pump management system 102 may cause the turbo pump to operate at the pump speed while the mass spectrometer operates in accordance with the operating mode. Pump management system 102 may cause the turbo pump to operate at the pump speed in any suitable manner. For example, pump management system 102 may transmit a command to the turbo pump that sets the pump speed, adjust an operating power or voltage associated with the pump speed, and/or otherwise cause the turbo pump to operate at a desired pump speed.

Various examples of determining an operating mode for the mass spectrometer, setting, based on the operating mode, a pump speed of a turbo pump used to create one or more vacuum stages for the mass spectrometer, and causing the turbo pump to operate at the pump speed will now be provided.

In some examples, pump management system 102 may determine that the operating mode is a first operating mode (e.g., a “small molecule” mode or a “peptide mode”) when a molecule size of a sample to be analyzed by the mass spectrometer is less than a threshold molecule size. In this case, high pressure levels in the first few vacuum stages of the mass spectrometer may have no beneficial effect and can even cause problems (e.g., long ion flight times that slow down the spectral acquisition rates and degrade ion filter and detector performance). Hence, based on the operating mode being the first operating mode, pump management system 102 may set the pump speed to be above a threshold pump speed, thereby causing the vacuum stages to have relatively low pressure levels (e.g., less than 150 mTorr in the first vacuum region after an ion funnel of an atmospheric pressure inlet associated with the mass spectrometer).

Alternatively, pump management system 102 may determine that the operating mode is a second operating mode (e.g., a “large molecule” mode) when the molecule size of the sample to be analyzed by the mass spectrometer is greater than the threshold molecule size. In this case, effective desolvation of these large ions may require large voltage drops between vacuum stages (e.g., “in-source dissociation”). To accommodate these large, fast moving molecules, relatively high gas pressures in downstream vacuum stages may be required. Accordingly, in this case, the pump speed may be set to be below the threshold pump speed, thereby causing the vacuum stages to have relatively high pressure levels (e.g., greater than 150 mTorr in the first vacuum region after an ion funnel of an atmospheric pressure inlet associated with the mass spectrometer).

As another example, if pump management system 102 determines that the mass spectrometer will operate to perform a bakeout process for one or more components of the mass spectrometer, pump management system 102 may set the pump speed to below a threshold pump speed. This may cause the pump to generate less heat from running at a lower pump speed, which may allow other regions of the mass spectrometer to heat up to a high temperature level during the bakeout process without surpassing any temperature limits inside the one or more components.

As another example, pump management system 102 may determine that the mass spectrometer will operate to perform a collision-based mass spectrometry process. As mentioned, this particular process may require or otherwise be optimized by a relatively high pressure level within one or more vacuum stages created by a turbo pump associated with the mass spectrometer. Accordingly, pump management system 102 may set the pump speed to below a threshold pump speed.

In some examples, pump management system 102 may additionally and/or alternatively monitor one or more conditions associated with the mass spectrometer while the mass spectrometer is in operation and adjust the pump speed of the turbo pump to account for changes in the one or more conditions.

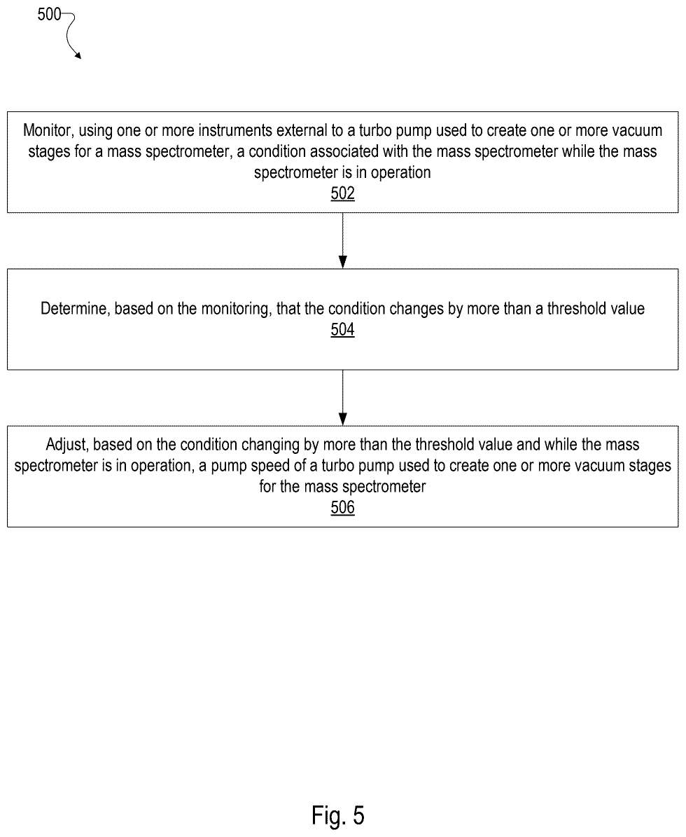

To illustrate, FIG. 5 shows another illustrative method 500 for managing a turbo pump for a mass spectrometer. While FIG. 5 shows illustrative operations according to one embodiment, other embodiments may omit, add to, reorder, and/or modify any of the operations shown in FIG. 5. One or more of the operations shown in FIG. 5 may be performed by pump management system 102, one or more any components included therein, and/or any implementation thereof.

At operation 502, pump management system 102 may monitor, using one or more instruments external to a turbo pump used to create one or more vacuum stages for a mass spectrometer, a condition associated with the mass spectrometer while the mass spectrometer is in operation (e.g., while the mass spectrometer operates in accordance with an operating mode to analyze a sample).

The condition may include any suitable type of condition associated with the mass spectrometer. For example, the condition may include a temperature level associated with one or more components of the mass spectrometer and/or the turbo pump. Additionally and/or alternatively, the condition may include a pressure level within at least one of the one or more vacuum stages created by the turbo pump. Additionally and/or alternatively, the condition may include a runtime duration associated with the mass spectrometer, an error rate or event associated with the mass spectrometer (e.g., contamination events, inaccurate calibration events, etc.), a humidity level associated with the turbo pump and/or one or more components of the mass spectrometer, etc.

As mentioned, pump management system 102 may use one or more instruments external to (e.g., not included within) the turbo pump to monitor the condition associated with the mass spectrometer. For example, the one or more instruments may include one or more sensors and/or gauges located within one or more components of the mass spectrometer. Additionally or alternatively, the one or more instruments may be external to the mass spectrometer. For example, the one or more instruments may include one or more sensors and/or gauges located within an environment (e.g., a laboratory) of the mass spectrometer. The one or more sensors and/or gauges may be configured to measure temperature, pressure levels, etc. as may serve a particular implementation.

At operation 504, pump management system 102 may determine, based on the monitoring, that the condition changes by more than a threshold value. The threshold value may be selected based on one or more characteristics of a component associated with the condition. For example, the characteristic may include a maximum or ideal operating temperature and/or pressure level associated with the component.

At operation 506, pump management system 102 may adjust, based on the condition changing by more than the threshold value and while the mass spectrometer is in operation, a pump speed of a turbo pump used to create one or more vacuum stages for the mass spectrometer.

For example, the pump speed may be decreased based on a determination that a temperature level associated with the turbo pump and/or the mass spectrometer increases by more than the threshold value. This may help decrease or otherwise regulate the temperature level, thereby preventing or minimizing downtime required for instrument cool down if the temperature level gets too high.

Correspondingly, the pump speed may be increased based on a determination that the temperature level decreases by more than the threshold value. For example, after decreasing the pump speed to help cool down a component of the mass spectrometer, pump management system 102 may determine that temperature level returns to be within an acceptable range. Pump management system 102 may then increase the pump speed to what it was before the pump speed was decreased.

In some embodiments, adjusting the pump speed may include temporarily shutting down the turbo pump and/or other components of the vacuum system of the mass spectrometer.

While operation 506 is described as adjusting a pump speed based on the condition changing by more than a threshold value, it is to be appreciated that the pump speed may be adjusted based on the condition satisfying any suitable criteria associated with the mass spectrometer. For example, the criteria may include one or more of the condition exceeding a threshold value, the condition dropping below a threshold value, and/or a rate of change of the condition exceeding a threshold value. In some examples, the criteria may include a determination that the condition will change by more than the threshold value within a certain time period and/or operating session.

In some embodiments, the pump speed may be continuously adjusted over time based on the value of the condition. For example, the pump speed may be continuously decreased as a temperature level associated with the mass spectrometer increases. Similarly, the pump speed may be continuously increased as the temperature level decreases.

While method 500 is shown as including operations 502-506, it is to be appreciated that method 500 may include any number of additional and/or alternative operations associated with managing the turbo pump for the mass spectrometer. In some embodiments, for example, pump management system 102 may continue to monitor the condition associated with the mass spectrometer after the pump speed has been adjusted. Pump management system 102 may determine that the condition reverses at least a portion of the change exceeding the threshold value. For example, if the condition increased by more than the threshold value, pump management system 102 may determine that the condition decreases by at least a portion of the threshold value. In some embodiments, the portion may be the entire threshold value, so that pump management system 102 determines that the condition reverses the entire change (e.g., returned to a value before the change occurred).

Pump management system 102 may readjust the pump speed based on the determination that the condition reverses at least the portion of the change. For example, the pump speed may be returned to a setting and/or value set for the pump speed before the adjustment of the pump speed.

In some embodiments, pump management system 102 may manage multiple turbo pumps used to create a plurality of vacuum stages for the mass spectrometer. Pump management system 102 may selectively adjust any combination of the turbo pumps based on the condition. For example, pump management system 102 may maintain the pump speed of one or more turbo pumps while adjusting the pump speed of a particular turbo pump (e.g., at operation 506). In some embodiments, the one or more turbo pumps may be associated with one or more earlier stages for the mass spectrometer than the particular turbo pump. For example, the one or more turbo pumps may be associated with mass analyzer 306-1 while the particular turbo pump is associated with mass analyzer 306-2.

In some embodiments, pump management system 102 may monitor a plurality of conditions associated with the mass spectrometer. Pump management system 102 may determine that each of the plurality of the conditions changes by more than a respective threshold value. For example, pump management system 102 may determine that a temperature level associated with a first component of the mass spectrometer changes by more than a first threshold value and a temperature level associated with a second component of the mass spectrometer changes by more than a second threshold value.

Pump management system 102 may adjust, based on the plurality of conditions changing by more than the respective threshold values and while the mass spectrometer is in operation, a pump speed of a turbo pump used to create one or more vacuum stages for the mass spectrometer. For example, the pump speed may be decreased based on a determination a temperature level associated with a first component of the mass spectrometer increases by more than a first threshold value and a temperature level associated with a second component of the mass spectrometer increases by more than a second threshold value.

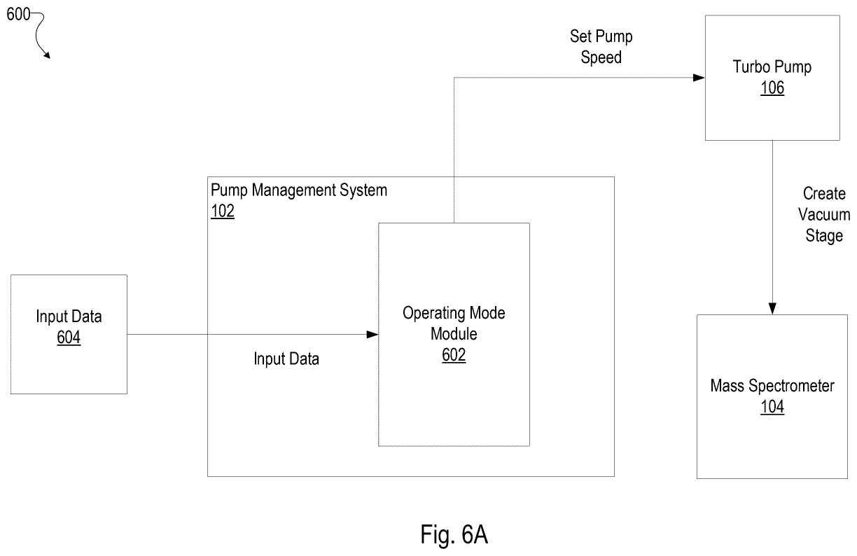

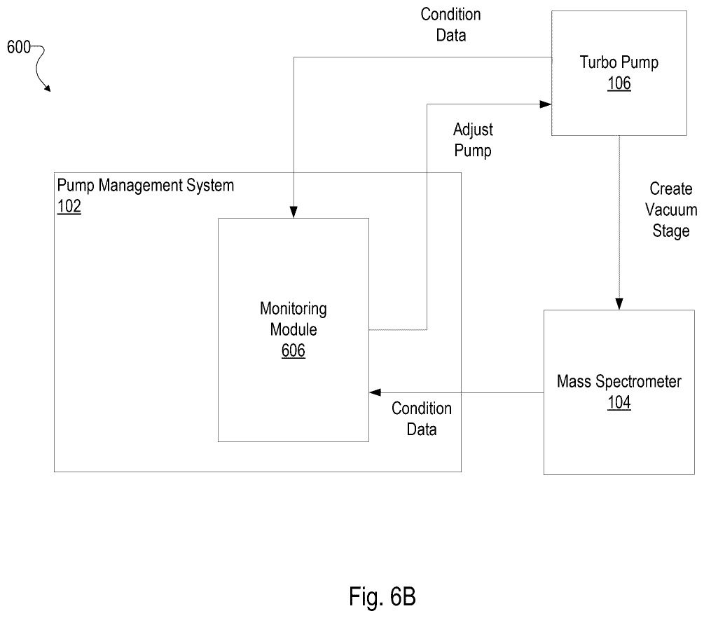

FIG. 6A shows an illustrative configuration 600 for managing a turbo pump for a mass spectrometer. As shown, configuration 600 may include pump management system 102, mass spectrometer 104, and turbo pump 106. Configuration 600 may operate to carry out various pump management functions as described herein, such as any of operations 402-406 of method 400 and/or operations 502-206 of method 500.

Pump management system 102 may include one or more modules for performing pump management functions. As shown, pump management system 102 may include an operating mode module 602. Operating mode module 602 may be implemented by any suitable combination of hardware and/or software (e.g., by processing facility 204). Operating mode module 602 may be configured to set a pump speed of turbo pump 106 based on an operating mode for mass spectrometer 104 (e.g., by performing operations 402-406). For example, as shown, operating mode module 602 may receive input data 604. Input data 604 may include any type of input data as described herein, such as user input indicating a selection of an operating mode for mass spectrometer 104. Operating mode module 602 may determine an operating mode based on input data 604. Operating mode module 602 may set a pump speed of turbo pump 106 and cause turbo pump 106 to operate at the pump speed to create one or more vacuum stages for mass spectrometer 104.

As shown in FIG. 6B, pump management system 102 may additionally and/or alternatively include a monitoring module 606. Monitoring module 606 may be implemented by any suitable combination of hardware and/or software (e.g., by processing facility 204). Monitoring module 606 may be configured to adjust a pump speed of turbo pump 106 based on a condition associated with mass spectrometer 104 and/or turbo pump 106 (e.g., by performing operations 502-506). For example, as shown, monitoring module 606 may receive condition data from turbo pump 106 and/or mass spectrometer 104 while monitoring turbo pump 106 and/or mass spectrometer 104. The condition data may indicate a condition associated with turbo pump 106 and/or mass spectrometer 104. Monitoring module 606 may determine that the condition indicated by the condition data changes by more than a threshold value (and/or otherwise satisfies one or more criteria). Monitoring module 606 may adjust a pump speed of turbo pump 106 based on the determination. Turbo pump 106 may create one or more vacuum stages for mass spectrometer 104 based on the adjusted pump speed.

In certain embodiments, one or more of the systems, components, and/or processes described herein may be implemented and/or performed by one or more appropriately configured computing systems or devices. To this end, one or more of the systems and/or components described above may include or be implemented by any computer hardware and/or computer-implemented instructions (e.g., software) embodied on at least one non-transitory computer-readable medium configured to perform one or more of the processes described herein. In particular, system components may be implemented on one physical computing system or device or may be implemented on more than one physical computing system or device. Accordingly, system components may include any number of computing systems and devices, and may employ any of a number of computer operating systems.

In certain embodiments, one or more of the processes described herein may be implemented at least in part as instructions embodied in a non-transitory computer-readable medium and executable by one or more computing systems. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a compact disc read-only memory (“CD-ROM”), a digital video disc (“DVD”), any other optical medium, random access memory (“RAM”), programmable read-only memory (“PROM”), electrically erasable programmable read-only memory (“EPROM”), FLASH-EEPROM, any other memory chip or cartridge, or any other tangible medium from which a computer can read.

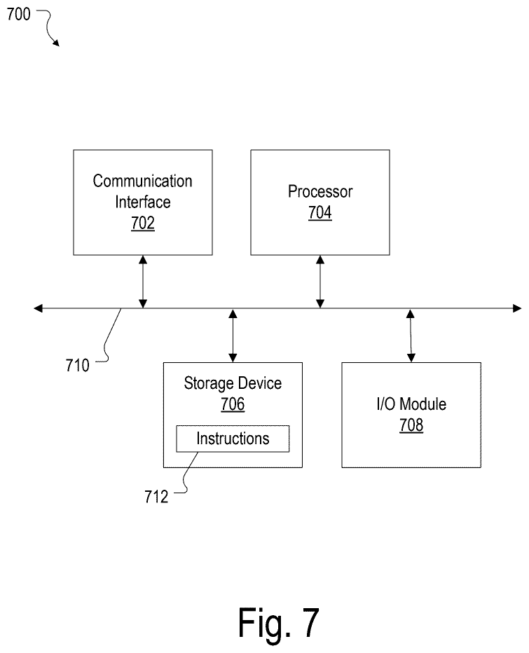

FIG. 7 shows an illustrative computing device 700 that may be specifically configured to perform one or more of the operations, methods, and processes described herein. Any of the systems, computing devices, and/or other components described herein may be implemented by computing device 700.

As shown in FIG. 7, computing device 700 may include a communication interface 702, a processor 704, a storage device 706, and an input/output (“I/O”) module 708 communicatively connected one to another via a communication infrastructure 710. While an illustrative computing device 700 is shown in FIG. 7, the components illustrated in FIG. 7 are not intended to be limiting. Additional or alternative components may be used in other embodiments. Components of computing device 700 shown in FIG. 7 will now be described in additional detail.

Communication interface 702 may be configured to communicate with one or more computing devices. Examples of communication interface 702 include, without limitation, a wired network interface (such as a network interface card), a wireless network interface (such as a wireless network interface card), a modem, an audio/video connection, and any other suitable interface.

Processor 704 generally represents any type or form of processing unit capable of processing data and/or interpreting, executing, and/or directing execution of one or more of the instructions, processes, and/or operations described herein. Processor 704 may perform operations by executing computer-executable instructions 712 (e.g., an application, software, code, and/or other executable data instance) stored in storage device 706.

Storage device 706 may include one or more data storage media, devices, or configurations and may employ any type, form, and combination of data storage media and/or device. For example, storage device 706 may include, but is not limited to, any combination of the non-volatile media and/or volatile media described herein. Electronic data, including data described herein, may be temporarily and/or permanently stored in storage device 706. For example, data representative of computer-executable instructions 712 configured to direct processor 704 to perform any of the operations described herein may be stored within storage device 706. In some examples, data may be arranged in one or more databases residing within storage device 706.

I/O module 708 may include one or more I/O modules configured to receive user input and provide user output. One or more I/O modules may be used to receive input for a single virtual experience. I/O module 708 may include any hardware, firmware, software, or combination thereof supportive of input and output capabilities. For example, I/O module 708 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 708 is configured to provide graphical data to a display for presentation to a user. The graphical data may be representative of one or more graphical user interfaces and/or any other graphical content as may serve a particular implementation.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

Advantages and features of the present disclosure can be further described by the following statements:

Example 1. A method comprising: determining, by a pump management system, an operating mode for a mass spectrometer; setting, by the pump management system based on the operating mode, a pump speed of a turbo pump used to create one or more vacuum stages for the mass spectrometer; and causing, by the pump management system, the turbo pump to operate at the pump speed while the mass spectrometer operates in accordance with the operating mode.

Example 2. The method of example 1, wherein: the determining the operating mode for the mass spectrometer comprises: determining that the operating mode is a first operating mode when a molecule size of a sample to be analyzed by the mass spectrometer is less than a threshold molecule size, and determining that the operating mode is a second operating mode when the molecule size of the sample to be analyzed by the mass spectrometer is greater than the threshold molecule size; and the setting the pump speed comprises: setting the pump speed to be above a threshold pump speed for the first operating mode, and setting the pump speed to be below the threshold pump speed for the second operating mode.

Example 3. The method of any of the foregoing examples, wherein the determining the operating mode occurs prior to the mass spectrometer operating in accordance with the operating mode.

Example 4. The method of any of the foregoing examples, further comprising: obtaining, by the pump management system, input data provided by a user; wherein the determining the operating mode for the mass spectrometer is based on the input data provided by the user.

Example 5. The method of any of the foregoing examples, wherein the obtaining the input data comprises detecting a selection by the user of a particular operating mode from a list of predefined operating modes presented within a user interface provided by an application executed by a computing device configured to control the mass spectrometer.

Example 6. The method of any of the foregoing examples, wherein the determining the operating mode for the mass spectrometer is based on determining that the mass spectrometer will operate to perform a collision-based mass spectrometry process.

Example 7. The method of any of the foregoing examples, wherein the determining the operating mode for the mass spectrometer is based on a sample to be analyzed by the mass spectrometer including an oligonucleotide.

Example 8. The method of any of the foregoing examples, wherein the determining the operating mode for the mass spectrometer is based on determining that the mass spectrometer will operate to perform a bakeout process for one or more components of the mass spectrometer; and the setting the pump speed comprises setting the pump speed to be below a threshold pump speed.

Example 9. The method of any of the foregoing examples, further comprising: monitoring, by the pump management system, a condition associated with the mass spectrometer while the mass spectrometer operates in accordance with the operating mode; determining, by the pump management system based on the monitoring, that the condition changes by more than a threshold value; and adjusting, by the pump management system based on the condition changing by more than the threshold value and while the mass spectrometer is in operation, the pump speed.

Example 10. The method of any of the foregoing examples, wherein the condition comprises a temperature level associated with at least one of the turbo pump or one or more components of the mass spectrometer.

Example 11. The method of any of the foregoing examples, wherein: the determining that the condition changes by more than the threshold value comprises determining that the temperature level increases by more than the threshold value; and the adjusting the pump speed comprises decreasing the pump speed.

Example 12. The method of any of the foregoing examples, wherein the condition comprises a pressure level within at least one of the one or more vacuum stages.

Example 13. The method of any of the foregoing examples, wherein: the determining that the condition changes by more than the threshold value comprises determining that the pressure level increases by more than the threshold value; and the adjusting the pump speed comprises increasing the pump speed.

Example 14. The method of any of the foregoing examples, wherein the pump speed specifies a frequency at which one or more fan blades rotate within the turbo pump to create the one or more vacuum stages.

Example 15. A method comprising: monitoring, by a pump management system using one or more instruments external to a turbo pump used to create one or more vacuum stages for a mass spectrometer, a condition associated with the mass spectrometer while the mass spectrometer is in operation; determining, by the pump management system based on the monitoring, that the condition changes by more than a threshold value; and adjusting, by the pump management system based on the condition changing by more than the threshold value and while the mass spectrometer is in operation, a pump speed of the turbo pump.

Example 16. The method of any of the foregoing examples, wherein the condition comprises a temperature level associated with at least one of the turbo pump or one or more components of the mass spectrometer.

Example 17. The method of any of the foregoing examples, wherein: the determining that the condition changes by more than threshold value comprises determining that the temperature level increases by more than the threshold value; and the adjusting the pump speed comprises decreasing the pump speed.

Example 18. The method of any of the foregoing examples, wherein the condition comprises a pressure level within at least one of the one or more vacuum stages.

Example 19. The method of any of the foregoing examples, further comprising: determining, by the pump management system, an operating mode for the mass spectrometer; wherein the adjusting the pump speed is further based on the operating mode.

Example 20. A system comprising: a mass spectrometer configured to analyze molecules of a sample; a computing device communicatively coupled with the mass spectrometer and configured to perform a process comprising: determining an operating mode for the mass spectrometer; setting, based on the operating mode, a pump speed of a turbo pump used to create one or more vacuum stages for the mass spectrometer; and causing the turbo pump to operate at the pump speed while the mass spectrometer operates in accordance with the operating mode.

What is claimed is:

1. A method comprising:
determining, by a pump management system, an operating mode for a mass spectrometer;
setting, by the pump management system based on the operating mode, a pump speed of a turbo pump used to create one or more vacuum stages for the mass spectrometer; and
causing, by the pump management system, the turbo pump to operate at the pump speed while the mass spectrometer operates in accordance with the operating mode.

2. The method of claim 1, wherein:
the determining the operating mode for the mass spectrometer comprises:
determining that the operating mode is a first operating mode when a molecule size of a sample to be analyzed by the mass spectrometer is less than a threshold molecule size, and
determining that the operating mode is a second operating mode when the molecule size of the sample to be analyzed by the mass spectrometer is greater than the threshold molecule size; and
the setting the pump speed comprises:
setting the pump speed to be above a threshold pump speed for the first operating mode, and
setting the pump speed to be below the threshold pump speed for the second operating mode.

3. The method of claim 1, wherein the determining the operating mode occurs prior to the mass spectrometer operating in accordance with the operating mode.

4. The method of claim 1, further comprising:
obtaining, by the pump management system, input data provided by a user;
wherein the determining the operating mode for the mass spectrometer is based on the input data provided by the user.

5. The method of claim 4, wherein the obtaining the input data comprises detecting a selection by the user of a particular operating mode from a list of predefined operating modes presented within a user interface provided by an application executed by a computing device configured to control the mass spectrometer.

6. The method of claim 1, further comprising:
determining, by the pump management system, that the mass spectrometer will operate to perform a specific type of mass spectrometry process;
wherein the determining the operating mode for the mass spectrometer is based on the determining that the mass spectrometer will operate to perform the specific type of mass spectrometry process.

7. The method of claim 1, further comprising:
identifying, by the pump management system, a characteristic of a sample to be analyzed by the mass spectrometer;
wherein the determining the operating mode for the mass spectrometer is based on the identifying the characteristic.

8. The method of claim 1, wherein the determining the operating mode for the mass spectrometer is based on determining that the mass spectrometer will operate to perform a bakeout process for one or more components of the mass spectrometer; and
the setting the pump speed comprises setting the pump speed to be below a threshold pump speed.

9. The method of claim 1, further comprising:
monitoring, by the pump management system, a condition associated with the mass spectrometer while the mass spectrometer operates in accordance with the operating mode;
determining, by the pump management system based on the monitoring, that the condition changes by more than a threshold value; and
adjusting, by the pump management system based on the condition changing by more than the threshold value and while the mass spectrometer is in operation, the pump speed.

10. The method of claim 9, wherein the condition comprises a temperature level associated with at least one of the turbo pump or one or more components of the mass spectrometer.

11. The method of claim 10, wherein:
the determining that the condition changes by more than the threshold value comprises determining that the temperature level increases by more than the threshold value; and
the adjusting the pump speed comprises decreasing the pump speed.

12. The method of claim 9, wherein the condition comprises a pressure level within at least one of the one or more vacuum stages.

13. The method of claim 12, wherein:
the determining that the condition changes by more than the threshold value comprises determining that the pressure level increases by more than the threshold value; and
the adjusting the pump speed comprises increasing the pump speed.

14. The method of claim 1, wherein the pump speed specifies a frequency at which one or more fan blades rotate within the turbo pump to create the one or more vacuum stages.

15. A method comprising:
monitoring, by a pump management system using one or more instruments external to a turbo pump used to create one or more vacuum stages for a mass spectrometer, a condition associated with the mass spectrometer while the mass spectrometer is in operation;
determining, by the pump management system based on the monitoring, that the condition changes by more than a threshold value; and
adjusting, by the pump management system based on the condition changing by more than the threshold value and while the mass spectrometer is in operation, a pump speed of the turbo pump.

16. The method of claim 15, wherein the condition comprises a temperature level associated with at least one of the turbo pump or one or more components of the mass spectrometer.

17. The method of claim 16, wherein:
the determining that the condition changes by more than threshold value comprises determining that the temperature level increases by more than the threshold value; and
the adjusting the pump speed comprises decreasing the pump speed.

18. The method of claim 15, wherein the condition comprises a pressure level within at least one of the one or more vacuum stages.

19. The method of claim 15, further comprising:
determining, by the pump management system, an operating mode for the mass spectrometer;
wherein the adjusting the pump speed is further based on the operating mode.

20. A system comprising:
a mass spectrometer configured to analyze molecules of a sample;
a computing device communicatively coupled with the mass spectrometer and configured to perform a process comprising:
determining an operating mode for the mass spectrometer;
setting, based on the operating mode, a pump speed of a turbo pump used to create one or more vacuum stages for the mass spectrometer; and
causing the turbo pump to operate at the pump speed while the mass spectrometer operates in accordance with the operating mode.
